(19) United States
(12) Patent Application Publication
(10) Pub. No.: US 2014/0063253 A1
(43) Pub. Date: Mar. 6, 2014

(54) AVM SYSTEM OF VEHICLE FOR DIVIDING AND MANAGING CAMERA NETWORKS AND AVM METHOD THEREOF

(71) Applicant: KOREA ELECTRONICS TECHNOLOGY INSTITUTE, Seongnam-si (KR)

(72) Inventors: Sang Yub Lee, Yongin-si (KR); Hyo Sub Choi, Jeollabuk-do (KR); Sang Hyun Park, Seongnam-si (KR); Soo Young Min, Suwon-si (KR)

(73) Assignee: KOREA ELECTRONICS TECHNOLOGY INSTITUTE, Seongnam-si (KR)

(21) Appl. No.: 14/012,336

(22) Filed: Aug. 28, 2013

(30) Foreign Application Priority Data
Sep. 4, 2012 (KR) 10-2012-0097712

(51) Int. Cl. H04N 7/18

(52) U.S. Cl. CPC H04N 7/181
USPC 348/148

(57) ABSTRACT

The vehicle AVM system according to an exemplary embodiment of the present disclosure includes a first camera network constructed of some of the cameras configuring the AVM system; a second camera network constructed of some of the cameras configuring the AVM system; and a processor configured to create a first image from the images created by the cameras configuring the first camera network, and to create a second image from the images created by the cameras configuring the second camera network. Accordingly, by installing more number of cameras in an AVM system of a vehicle than the number of cameras in a general vehicle and thus removing dead zones according to vehicle characteristics, it becomes possible to perform smooth networking and prevent image delay, thereby preventing accidents due to dead zones and image delay.

### CROSS-REFERENCE TO RELATED APPLICATIONS

This application claims the benefit of priority under 35 U.S.C. § 119(a) of Korean Patent Application No. 10-2012-0097712, filed on Sep. 4, 2012, in the Korean Intellectual Property Office, the entire disclosure of which is incorporated herein by reference for all purposes.

### BACKGROUND

1. Field

The following description relates to An AVM (Around View Monitoring) system and method thereof, and more particularly, to an AVM system for monitoring situations surrounding a vehicle using cameras and a method thereof.

2. Description of Related Art

FIG. 1 is a view illustrating an AVM system for general vehicles. An AVM system for general vehicles is configured to include four cameras. The shaded portion in FIG. 1 is the area photographed by the cameras consisting of an AVM system. As illustrated, even when the AVM system consists of four cameras, almost no dead zone occurs.

However, unlike general vehicles, buses, special vehicles have high full height, full width, and full length, and thus when using a general vehicle AVM system, numerous dead zones occur.

FIG. 2 illustrates a situation where a general vehicle AVM system is applied to a bus, and FIG. 3 illustrates a top view of FIG. 2. According to claims 2 and 3, in a case of applying a general vehicle AVM system consisting of four cameras 10-1, 10-2, 10-3, and 10-4 to a bus, it can be seen that a dead zone may occur in the rear side portion, and since a person(s) could be moving in this dead zone, a safety accident may occur.

In order to resolve the aforementioned problem, a method of increasing the number of cameras in a bus AVM system may be conceived. However, when the number of cameras provided in an AVM system increases, the increased data would prevent smooth networking in the NIC (Network Interface Card, 20). This it even more true when considering the current trend of the resolution of cameras being commercialized in Full HD grade.

When networking is not made smoothly, a delay of image occurs, and since an image delay in an AVM system could lead to an outbreak of accident, this problem must be resolved.

Meanwhile, FIG. 4 illustrates a situation where a general vehicle AVM system is applied to a truck. Through what is illustrated in FIG. 4, it is presumable that a dangerous situation may occur even when a short person such as an infant or a low object is in the dead zone of the cameras 10-7, 10-8, and 10-9.

### SUMMARY

The present invention was devised to resolve the aforementioned problems, and the purpose of the present invention is to provide a vehicle AVM system where more number of cameras are installed in a special vehicle such as a bus, and truck than the number of cameras installed in a general vehicle so as to remove dead zones according to vehicle characteristics and realize smooth networking, thereby preventing image delay, and a method thereof.

In addition, the purpose of the present invention is to provide a vehicle system where cameras configuring the system are divided into multi networks, and each network creates and displays an image, and a method thereof.

In one general aspect, there is provided a vehicle AVM (Around View Monitoring) system, comprising: a first camera network constructed of some of the cameras configuring the AVM system; a second camera network constructed of some of the cameras configuring the AVM system; and a processor configured to create a first image from the images created by the cameras configuring the first camera network, and to create a second image from the images created by the cameras configuring the second camera network.

In addition, the vehicle AVM system according to the present exemplary embodiment may further include a first display where the first image is displayed; and a second display where the second image is displayed.

Furthermore, the cameras configuring the first camera network and the cameras configuring the second camera network may automatically change according to the proceeding direction of the vehicle.

In addition, in the first camera network, the cameras provided in the front direction of the vehicle may be included, and in the second camera network, the cameras provided in the rear direction of the vehicle may be included, when the vehicle goes straight or reverses.

Furthermore, in the first camera network, the cameras photographing the left side may be included, and in the second camera network, the cameras photographing the right side may be included, when the vehicle moves to the left side or right side.

In one general aspect, there is provided an AVM method comprising: creating a first image from the images created by the cameras configuring the first camera network of among the cameras configuring the vehicle AVM system; and creating a second image from the images created by the cameras configuring the second camera network of among the cameras configuring the AVM system.

As aforementioned, according to the present disclosure, by installing more number of cameras in an AVM system of a vehicle than the number of cameras in a general vehicle and thus removing dead zones according to vehicle characteristics, it becomes possible to perform smooth networking and prevent image delay, thereby preventing accidents due to dead zones and image delay.

Especially, since in a vehicle AVM system, the cameras configuring the system are divided into multi networks and configured, it becomes possible to disperse network traffic, thereby preventing image delay even when high performance cameras are applied.

Not only that, an image processing is performed in multiple network units, thereby alleviating complexity and load of image processing.

### BRIEF DESCRIPTION OF THE DRAWINGS

FIG. 1 is a view illustrating a general vehicle AVM system;

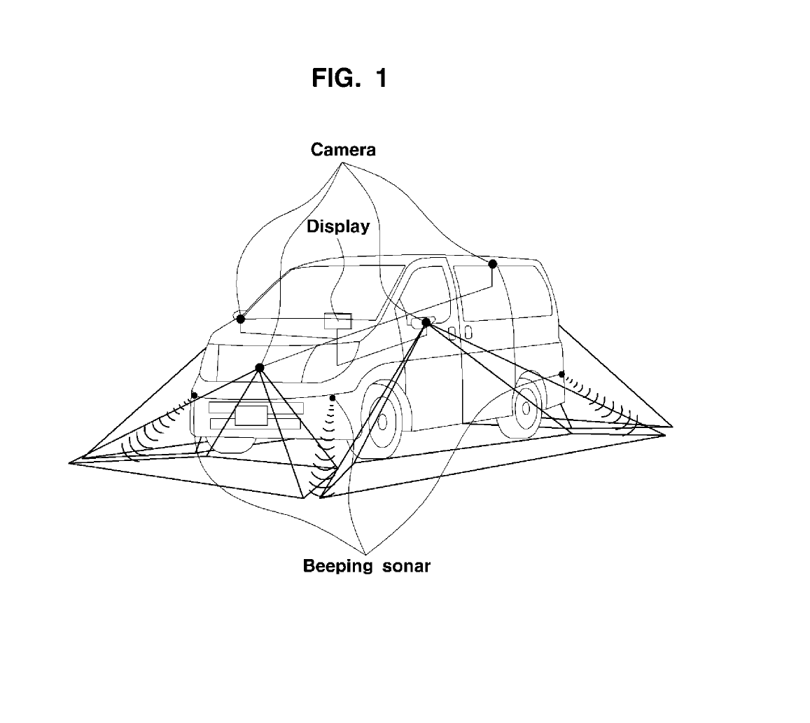

FIG. 2 illustrates a situation where a general vehicle AVM system is applied to a bus;

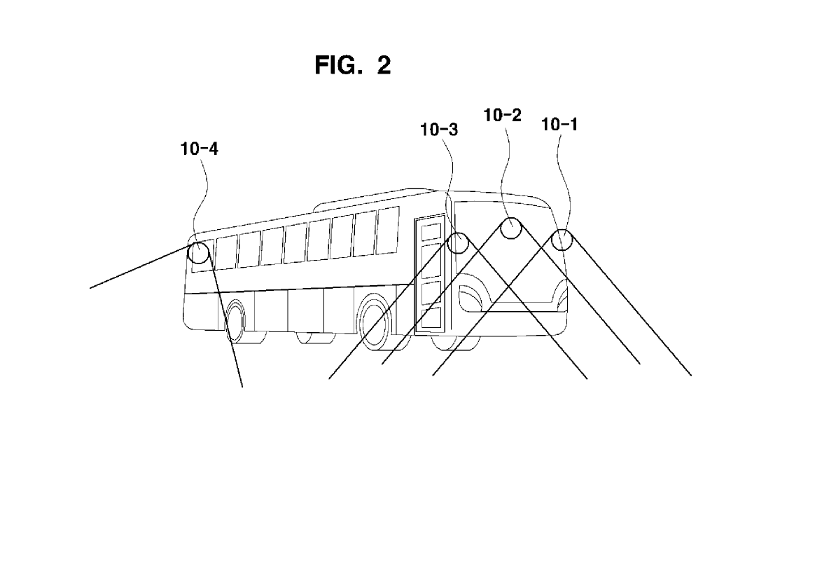

FIG. 3 is a top view of FIG. 2;

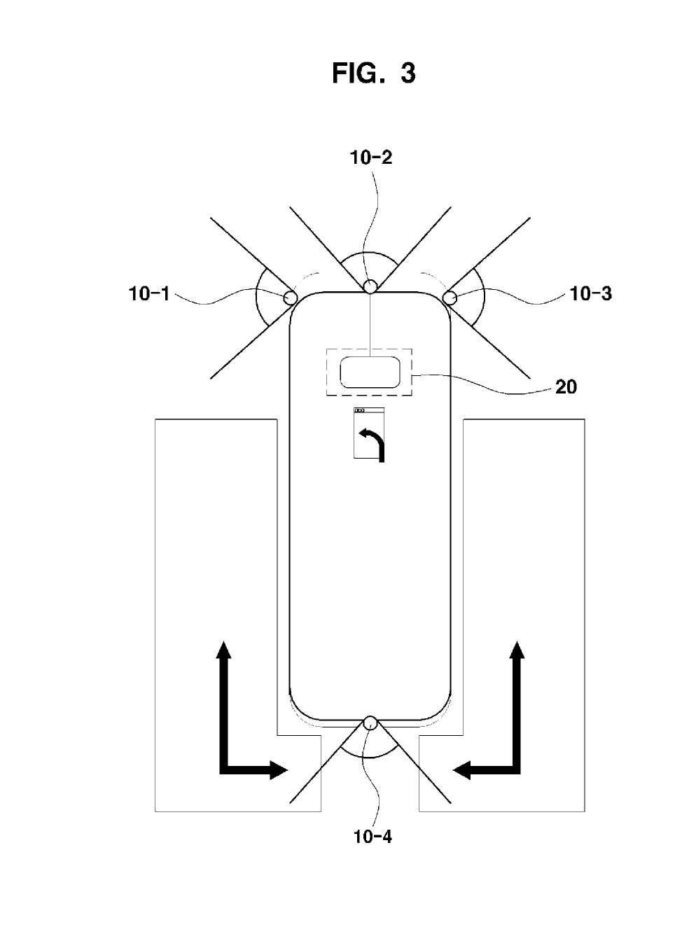

FIG. 4 is a view illustrating a situation where a general vehicle AVM system is applied to a truck;

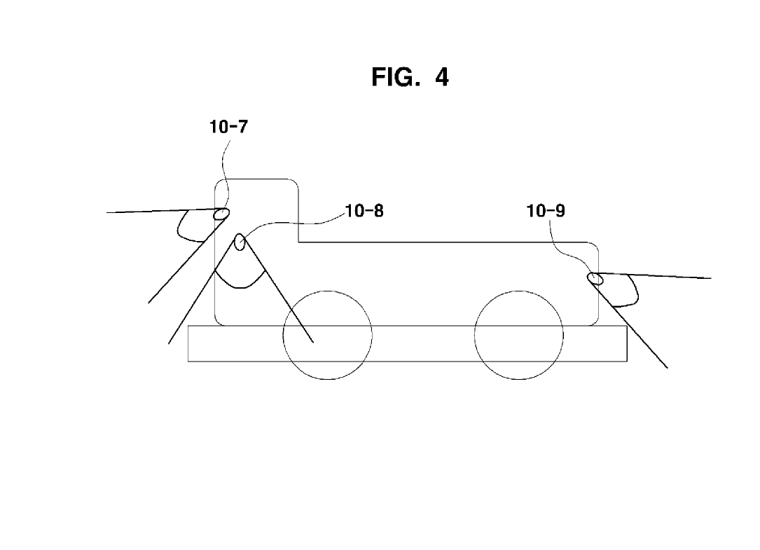

FIG. 5 is a view provided to explain a concept of a special vehicle AVM system according to an exemplary embodiment of the present disclosure;

FIG. 6 is a view illustrating a situation where a front direction image by a front direction camera network and a rear direction image by a rear direction camera network are divided and displayed on a display;

FIG. 7 is a view illustrating a situation where a left side camera network and right side camera network are established;

FIG. 8 is an internal block diagram of a special vehicle AVM system illustrated in FIG. 5; and

FIG. 9 is a view provided to explain a concept of a special vehicle AVM system according to another exemplary embodiment of the present disclosure.

Throughout the drawings and the detailed description, unless otherwise described, the same drawing reference numerals will be understood to refer to the same elements, features, and structures. The relative size and depiction of these elements may be exaggerated for clarity, illustrating, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

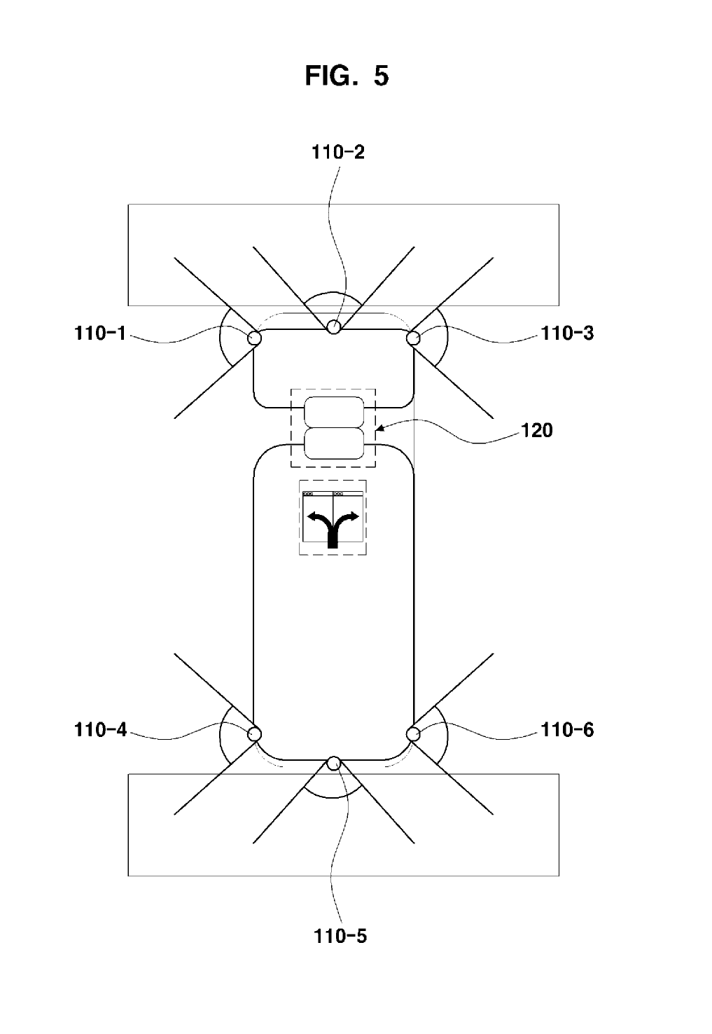

FIG. 5 is a view provided to explain a concept of a special vehicle AVM (Around View Monitoring) system according to an exemplary embodiment of the present disclosure. The special vehicle AVM system according to the present exemplary embodiment divides a camera network and operates the divided camera networks as multiple networks.

More specifically, as illustrated in FIG. 5, the AVM system according to the present exemplary embodiment is constructed by 1) ‘a front direction camera network’ consisting of a front direction/left side camera 110-1, front direction camera 110-2, and front direction/right side camera 110-3, and 2) ‘a rear direction camera network’ consisting of a rear direction/left side camera 110-4, rear direction camera 110-5, and rear direction/right side camera 110-6.

The front direction camera network and rear direction camera network are full duplex type ring network, that is, it is a separately divided network each of which is controlled by a different network controller.

A ‘front direction image’ is created by the cameras 110-1, 110-2, and 110-3 configuring the front camera network. In addition, a ‘rear direction image’ is created by images of the cameras 110-4, 110-5, and 110-6 configuring the rear direction camera network.

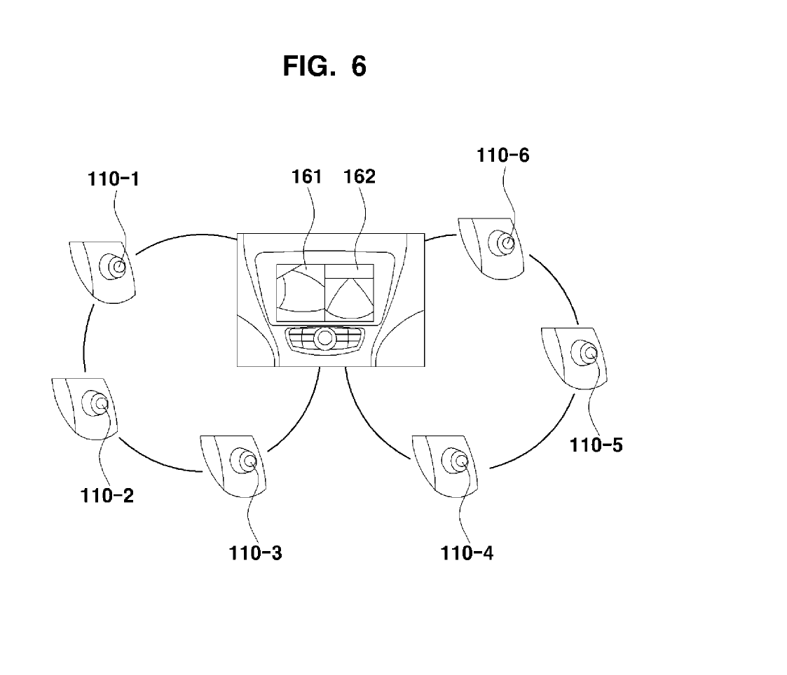

Each of the front direction image and rear direction image is displayed on each display, or displayed on a divided screen in one display. FIG. 6 illustrates a displayed result of the front direction image created by the images of the cameras 110-1, 110-2, and 110-3 forming the front direction camera network and of the rear direction image created by the images of the cameras 110-4, 110-5, and 110-6 forming the rear camera network.

For a special vehicle AVM system according to the present exemplary embodiment, a dynamic camera network may be configured. More specifically, it is possible to automatically change the cameras configuring the camera network according to the proceeding direction of the special vehicle.

For example, in a case where a special vehicle goes forward or reverses, as illustrated in FIG. 5, a front direction camera network is constructed by the cameras 110-1, 110-2, and 110-3 provided in the front direction, and a rear camera network may be constructed by the cameras 110-4, 110-5, and 110-6 provided in the rear direction.

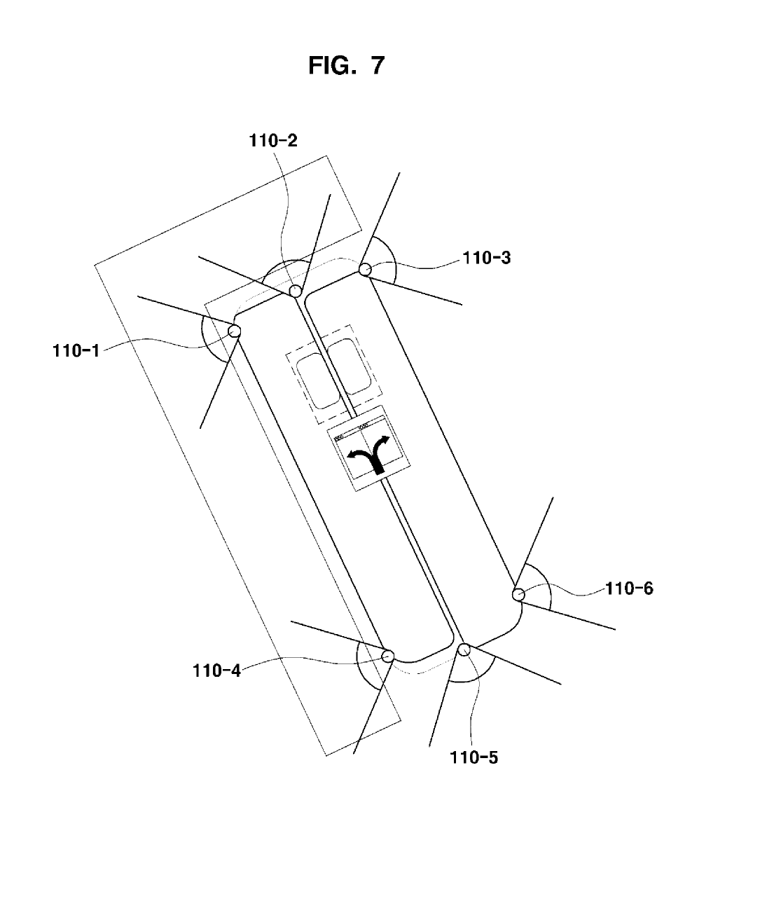

On the other hand, in a case where the vehicle goes forward or reverses while turning left or right, as illustrated in FIG. 7, a left side camera network may be constructed by the cameras 110-1 and 110-4 provided in the left side and the front direction camera 110-2, and a right camera network may be constructed by the cameras 110-3 and 110-6 provided in the right side and the right camera network.

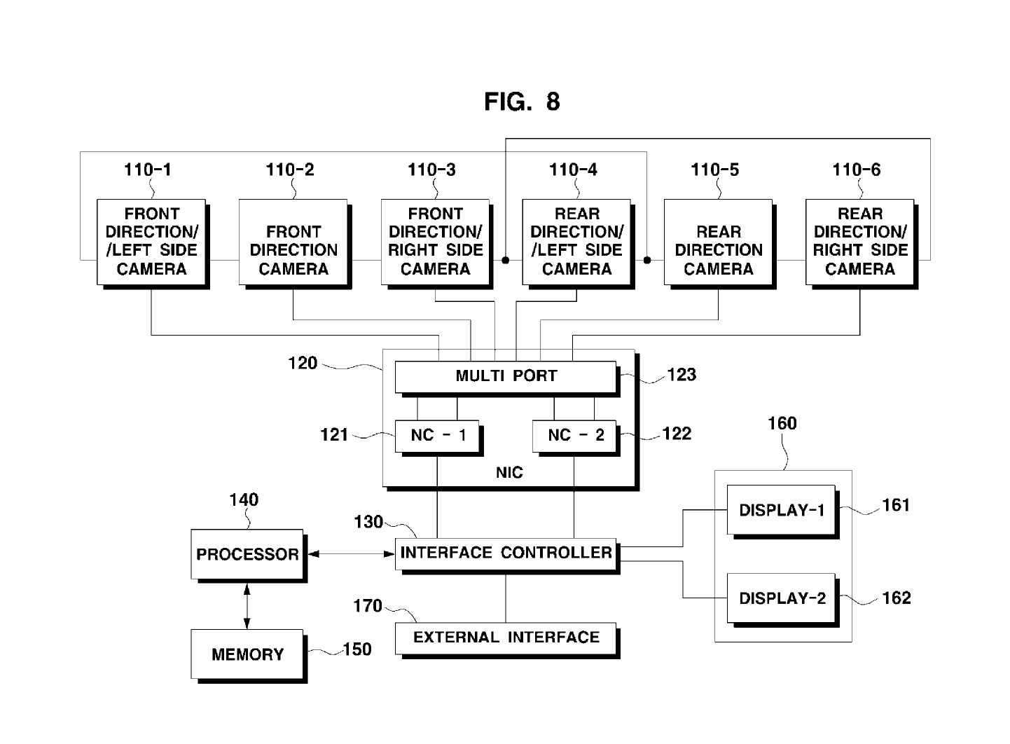

FIG. 8 is an internal block diagram of a special vehicle AVM system illustrated in FIG. 5. As illustrated in FIG. 8, the special vehicle AVM system is equipped with cameras 110-1 to 110-6, NIC (Network Interface Card) 120, interface controller 130, processor 140, memory 150, display 160, and external interface 170.

Cameras 110-1 to 110-6 photograph the front direction/left side, front direction, front direction/right side, rear direction/left side, rear direction and rear direction/right side of the special vehicle and creates an image.

The NIC 120 is equipped with an NC-1 (Network Controller-1) 121, NC-2 122, and multi port 123.

The multi port 123 is a switching element for selectively connecting the cameras 110-1 to 110-6 with NC-1 121 and NC-2 122.

When the vehicle goes straight or reverses, 1) NC-1 121 constructs a front direction camera network with front direction/left side camera 110-1, front direction camera 110-2, and front direction/right side camera 11-3 and controls networking, while 2) NC-2 122 constructs a rear direction camera network with rear direction/left side camera 110-4, rear direction camera 110-5, and rear direction/right side camera 110-6 and controls networking. This is already explained hereinabove with reference to FIG. 5.

Meanwhile, in a case where the vehicle goes straight or reverses while turning to the left or right, 1) NC-1 121 constructs a front direction camera network with a front direction/left side camera 110-1, front direction camera 110-2, and front direction/right side camera 110-3 and controls networking, and 2) NC-2 122 constructs a rear direction camera network with a rear direction/left side camera 110-4, rear direction camera 110-5, and rear direction/right side camera 110-6 and controls networking, and this is already explained hereinabove with reference to FIG. 5.

Meanwhile, in a case where the vehicle goes straight or reverses while turning left or right, 1) NC-1 121 constructs a left side camera network with a front direction camera 110-2, front direction/left side camera 110-1 and rear direction/left side camera 110-4 and controls networking, and 2) constructs a rear direction camera network with a front direction/right side camera 110-3, rear direction/right side camera 110-6, and rear direction camera 110-5 and controls networking, and thus is already explained hereinabove with reference to FIG. 7.

The interface controller 130 transmits communication interface among NC-1 121, NC-2 122, processor 140, display 160, and external interface 170.

The processor 140 composes the images transmitted through NC-1 121 and creates a front direction image or left image. In addition, the processor 140 composes the images transmitted through the NC-2 122 and creates a rear direction image and right direction image.

An image processing operation by the processor 140 is made separately. That is, the processor 140 divides the images transmitted through the NC-1 121 and the images transmitted through the NC-2 122, and processes the images to be multiple images.

The multiple image processing by the processor 140 alleviates complexity and load of image processing. That is because, image processing of composing six images and performing distortion correction is much more complex and has more load than making two image processing of performing distorting correction.

The memory 150 provides storage space for the processor 140 to perform image processing.

The display 160 is equipped with a display-1 161 and display-2 162, which may be physically divided displays, or screens divided from one display.

On display-1 161, an image created from the network constructed by NC-1 121 is displayed, and on display-2 162, an image created from the network constructed by NC-2 122 is displayed.

The external interface 170 is an interface supporting communication connection with other networks inside the vehicle.

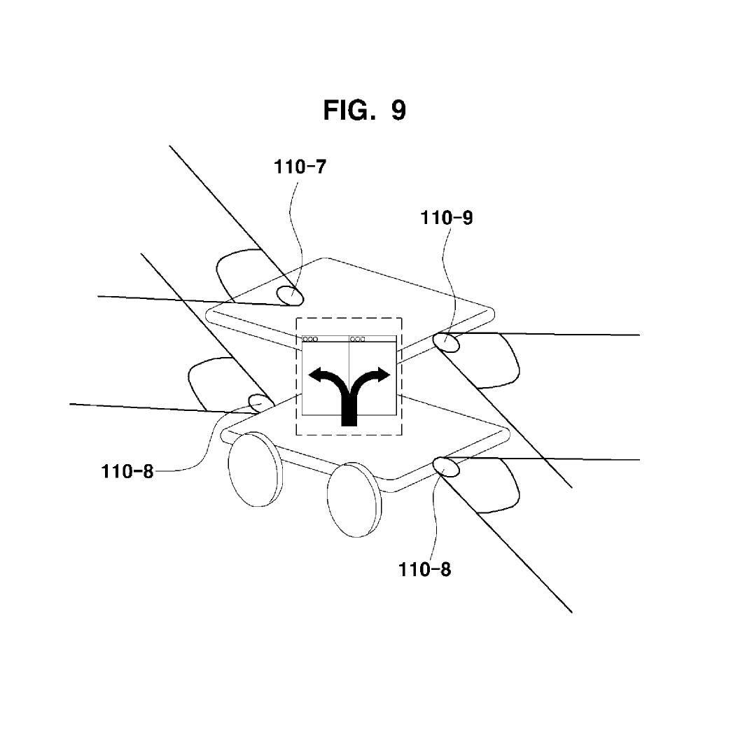

FIG. 9 is a view provided to explain a concept of a special vehicle AVM system according to another exemplary embodiment of the present disclosure. The special vehicle AVM system according to the present exemplary embodiment is different from the AVM system illustrated in FIG. 5 which photographs the same direction with one camera, in that it photographs the same direction with a plurality of cameras.

More specifically, the AVM system according to the present exemplary embodiment photographed the front direction in different directions with front direction/upper camera 110-7 and front direction/lower camera 110-8, and photographed the rear direction in different directions with rear direction/upper camera 110-9 and rear direction/lower camera 110-10, to prevent dead zones from occurring in low heights.

The AVM system illustrated in FIG. 9 uses the AVM system applied to a conventional general vehicle, but may change the location of the camera. When cameras are added in the side surface of the AVM system illustrated in FIG. 9 and thus the number of cameras exceeds four, as illustrated in FIG. 5, it is desirable to construct a multiple network.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A vehicle AVM (Around View Monitoring) system, comprising:
a first camera network constructed of some of the cameras configuring the AVM system;
a second camera network constructed of some of the cameras configuring the AVM system; and
a processor configured to create a first image from the images created by the cameras configuring the first camera network, and to create a second image from the images created by the cameras configuring the second camera network

2. The vehicle AVM system according to claim 1, further comprising:
a first display where the first image is displayed; and
a second display where the second image is displayed

3. The vehicle AVM system according to claim 1,
wherein the cameras configuring the first camera network and the cameras configuring the second camera network automatically change according to the proceeding direction of the vehicle

4. The vehicle AVM system according to claim 3,
wherein, in the first camera network, the cameras provided in the front direction of the vehicle are included, and in the second camera network, the cameras provided in the rear direction of the vehicle are included, when the vehicle goes straight or reverses

5. The vehicle AVM system according to claim 3,
wherein, in the first camera network, the cameras photographing the left side are included, and in the second camera network, the cameras photographing the right side are included, when the vehicle moves to the left side or right side

6. An AVM (Around View Monitoring) method comprising:
creating a first image from the images created by the cameras configuring the first camera network of among the cameras configuring the vehicle AVM system; and
creating a second image from the images created by the cameras configuring the second camera network of among the cameras configuring the AVM system
